(19) United States
(12) Patent Application Publication
(10) Pub. No.: US 2024/0013180 A1
(43) Pub. Date: Jan. 11, 2024

(54) ATHLETE NAME, IMAGE, AND LIKENESS MARKETING AND DIRECT PAYMENT SYSTEM

(71) Applicant: Brent Russell Chapman, Frisco, TX (US)

(72) Inventor: Brent Russell Chapman, Frisco, TX (US)

(21) Appl. No.: 18/370,580

(22) Filed: Sep. 20, 2023

Related U.S. Application Data
(63) Continuation-in-part of application No. 18/120,351, filed on Mar. 10, 2023.
(60) Provisional application No. 63/319,718, filed on Mar. 14, 2022.

(51) Int. Cl. G06Q 20/12; G06Q 50/18; G06Q 30/08; G06F 21/10

(52) U.S. Cl. CPC G06Q 20/1235; G06Q 50/184; G06Q 30/08; G06F 21/1074; G06F 21/1014; G06Q 40/10

(57) ABSTRACT

Disclosed is an athlete name, image, and likeness marketing and direct payment system and method comprising determining that an athlete is associated with an intercollegiate sports team of a university. The method includes identifying a set of parameters associated with a contractual relationship between the athlete and the university using a processor and a memory. The method further includes associating a set of restrictions to monetization of at least one of a name, an image and a likeness of the athlete based on the set of parameters associated with the contractual relationship between the athlete and the university. The method further includes determining a set of rules associated with a league in which the university participates with respect to compensation of the athlete. The method further automatically identifies a set of permissible revenue mechanisms available to the athlete.

### CLAIM OF PRIORITY

This application claims priority to, U.S. patent application Ser. No. 18/120,351 titled ATHLETE NAME, IMAGE, AND LIKENESS MARKETING AND DIRECT PAYMENT SYSTEM filed on Mar. 10, 2023 which is a conversion application of U.S. Provisional Patent Application No. 63/319,718 titled ATHLETE NAME, IMAGE, AND LIKENESS MARKETING AND DIRECT PAYMENT SYSTEM filed on Mar. 14, 2022. The entire disclosures of the aforementioned applications are incorporated herein by reference in entirety thereof.

### FIELD OF TECHNOLOGY

Disclosed is a method and/or system related generally to communication and payment systems, and more particularly, to an athlete name, image, and likeness (NIL) marketing and direct payment system.

### BACKGROUND

Many athletes earn no compensation for playing their sport, yet have a loyal fan base. For example, high school athletes and college athletes often do not earn money from playing their sport. However these same athletes can have a celebratory status—drawing audiences to follow and watch their talent. Oftentimes, these athletes garner revenue and profits for their sports program, university, conference, and/or league, but do not receive compensation for their contributions to these entities, despite these entities being irrelevant without the profit producing athletes.

In college athletics, a tradition of athletic amateurism had been the norm. College athletes could not profit off of their name, image, and/or likeness (“NIL”) without risking severe punishments including suspension, award revocations, loss of eligibility, and/or total banishment because such profits would not align with the amateurism tradition and league rules. Not only did athletes face consequences, the universities they attended could also face severe punishments such as loss of scholarships, win forfeitures, coaching and administrative suspensions, and/or complete program shutdowns.

Presently, college athletes may receive compensation, but only for limited activities and circumstances involving the athletes NIL. Currently athletes have no centralized location to market their name, image, or likeness for compensation. Likewise, fans and patrons do not have a means to directly fund athletes. As part of a typical NIL deal, an athlete participates in a quid-pro-quo arrangement where they may make appearances on behalf of a business, attend autograph sessions, wear branded merchandise, and/or promote a business on social media, but only a small portion of high-profile athletes are able to take advantage of these revenue streams. High-profile athletes in popular sports may receive lucrative endorsement deals, while athletes in less popular sports or at smaller schools may struggle to find opportunities. This could potentially create divisions within teams and athletic departments, and may invoke future due process litigation. Furthermore, NIL arrangements may also distract college athletes from their academic and athletic responsibilities. Students may prioritize seeking endorsement deals or managing their brand over their studies and training, impacting their overall college experience and performance.

Not only are there fairness issues and concerns about academic impact, there are significant compliance issues that may impact young athletes unfamiliar with university rules, league rules, contract laws, and tax laws and regulations that are directly invoked by their NIL income. Presently, it is challenging to monitor and enforce compliance with the varying state and institutional policies, potentially leading to NCAA violations and eligibility disputes. Universities have limited means to automatically assess an athlete's liability to and compliance with the different rules and tax laws and ordinances which may expose the universities to their own legal compliance liability. Athletes earning income from NIL arrangements may face tax implications that they might not fully understand, potentially leading to penalties or even criminal prosecution. Furthermore, young college athletes, particularly those from disadvantaged backgrounds, may be vulnerable to exploitation by agents or businesses seeking to profit from their NIL rights.

There may also be conflicts between athletes' personal endorsement deals and institutional sponsorships, leading to complex arrangements and negotiations. College athletes may also enter into contracts that significantly alter their ability to enter into new agreements as they progress to professional athletes. Without a centralized payment system available to all college athletes, these issues will continue to persist leading to significant harm to athletes. Therefore, what is needed is a centralized system that enables athletes to market their name, image, and/or likeness and receive direct payments for the same.

### SUMMARY

Disclosed method and/or system related generally to communication and payment systems, and more particularly, to an athlete name, image, and likeness (NIL) marketing and direct payment system.

In one aspect, a method comprises determining that an athlete is associated with an intercollegiate sports team of a university. The method includes identifying a set of parameters associated with a contractual relationship between the athlete and the university using a processor and a memory. The method then associates a set of restrictions to monetization of at least one of a name, an image and a likeness of the athlete based on the set of parameters associated with the contractual relationship between the athlete and the university. Next, the method determines a set of rules associated with a league in which the university participates with respect to compensation of the athlete. the method automatically identifies a set of permissible revenue mechanisms available to the athlete within the set of rules of the league and the set of restrictions with respect to the contractual relationship between the athlete and the university.

The method includes forming a license agreement in a variety of permutations based on artificial intelligence algorithm that analyzes at least one of a popularity of the athlete, a skill level of the athlete, a popularity of the university, a popularity of the intercollegiate sports team, a popularity of the league, a probabilistic playing career duration of the athlete, and potential sponsorship avenues likely available to the athlete in a present time and a foreseeable future. The method generates a non-fungible token which automatically encapsulates at least a portion of the set of permissible revenue mechanisms along with the license agreement. The method then permits a patron to compensate the athlete pursuant to the license agreement by purchasing the non-fungible token along with a set of privileges of ownership of the non-fungible token along with a set of rights licensed from the athlete to the patron.

The method may include generating the non-fungible token to include at least one identification property which enables a patron to identify the athlete associated with the non-fungible token. The method may generate a taxation report that is personalized to the athlete detailing an income received from the patron and a tax liability of the athlete. The method may generate a compliance report specific to the athlete wherein at least one of a payment amount, a patron information, a timestamp, and an athlete information is accessible to the university. The method may determine an access permission for the university and then permit the university to access the compliance report based on the determination of the access permission for the university. The method may automatically match a transfer request of the non-fungible token from the patron to a target blockchain, wherein the non-fungible token cannot be transferred unless the transfer request matches the target blockchain.

The method may determine if an information of the athlete is a qualifying credential wherein access of an athlete is granted if the information of the athlete is a qualifying credential. The method may analyze an activity of the patron for a violation wherein the violation bars the patron from compensating the athlete. The method may further process a set of bids from a plurality of patrons and determine which is a winning bid of the set of bids from the plurality of patrons. The method may automatically accept the winning bid on behalf of the athlete. Finally, the method transfers the non-fungible token to the patron in exchange for the compensation if the winning bid is accepted.

In another aspect, a method comprises creating a profile for a patron using a processor and a memory. The method includes determining that an athlete is associated with an intercollegiate sports team of a university by matching at least one information of the athlete to at least one qualifying credential. The method identifies a set of parameters associated with a contractual relationship between the athlete and the university using the processor and the memory. The method then associates a set of restrictions to monetization of at least one of a name, an image and a likeness of the athlete based on the set of parameters associated with the contractual relationship between the athlete and the university. The method establishes at least one permissible revenue mechanism available to the athlete within the set of rules of the league and the set of restrictions with respect to the contractual relationship between the athlete and the university. The method derives a monetization consideration from at least one of the name, the image, and the likeness of the athlete based on the set of parameters associated with the contractual relationship between the athlete and the university.

The method processes a set of bids for the monetization consideration from a plurality of patrons. wherein the set of bids is a compensation that is offered for the at least one permissible revenue mechanism. The method includes determining which is a winning bid of the set of bids from the plurality of patrons and automatically accepts the winning bid on behalf of the athlete. The method transfers the monetization consideration to the patron in exchange for the compensation if the winning bid is accepted by the athlete. The method may further form a license agreement in a variety of permutations based on artificial intelligence algorithm that analyzes at least one of a popularity of the athlete, a skill level of the athlete, a popularity of the university, a popularity of the intercollegiate sports team, a popularity of the league, a probabilistic playing career duration of the athlete, and potential sponsorship avenues likely available to the athlete in a present time and a foreseeable future.

The method may permit the patron to compensate the athlete pursuant to the license agreement by purchasing the monetization consideration in the form of a non-fungible token along with a set of privileges of ownership of the non-fungible token along with a set of rights licensed from the athlete to the patron. The method may include wherein the non-fungible token automatically encapsulates at least a portion of the set of permissible revenue mechanisms along with the license agreement. After receiving the set of bids, the method may confirm the athlete's identity by prompting the athlete to confirm the at least one athlete information. The method may create an account for the athlete if the athlete confirms the at least one information of the athlete is at least one qualifying credential. The method may generate a taxation report that is personalized to the athlete detailing an income received from the patron and a tax liability of the athlete. The method may generate a compliance report specific to the athlete wherein at least one of a payment amount, a patron information, a timestamp, and at least one athlete information is accessible to the university. The method may determine an access permission for the university and permit the university to access the compliance report based on the determination of the access permission for the university. The method may further analyze an activity of the patron for a violation wherein the violation bars the patron from compensating the athlete.

In yet another embodiment, a system comprises a processing system having a processor and a memory a network; and a plurality of submodules which determines that an athlete is associated with an intercollegiate sports team of a university by assessing at least one information of the athlete for a qualifying credential. The system identifies a set of parameters associated with a contractual relationship between the athlete and the university using a processor and a memory. The system associates a set of restrictions to monetization of at least one of a name, an image and a likeness of the athlete based on the set of parameters associated with the contractual relationship between the athlete and the university. The system then determines a set of rules associated with a league in which the university participates with respect to compensation of the athlete.

The system automatically identifies a set of permissible revenue mechanisms available to the athlete within the set of rules of the league and the set of restrictions with respect to the contractual relationship between the athlete and the university. The system forms a license agreement in a variety of permutations based on artificial intelligence algorithm that analyzes at least one of a popularity of the athlete, a skill level of the athlete, a popularity of the university, a popularity of the intercollegiate sports team, a popularity of the league, a probabilistic playing career duration of the athlete, and potential sponsorship avenues likely available to the athlete in a present time and a foreseeable future. The system then generates a non-fungible token which automatically encapsulates at least a portion of the set of permissible revenue mechanisms along with the license agreement.

The system permits a patron to compensate the athlete pursuant to the license agreement by purchasing the non-fungible token along with a set of privileges of ownership of the non-fungible token along with a set of rights licensed from the athlete to the patron. The system generates a taxation report that is personalized to the athlete. The system creates a compliance report specific to the athlete wherein at least one of a payment amount, a patron information, a timestamp, and an athlete information is accessible to the university. The system determines an access permission for the university and permits the university to access the compliance report based on the determination of the access permission for the university. The system then analyzes an activity of the patron for a violation wherein the violation bars the patron from compensating the athlete.

### BRIEF DESCRIPTION OF THE DRAWING

The embodiments of this invention are illustrated by way of example and not limitation in the figures of the accompanying drawings, in which like references indicate similar elements and in which:

FIG. 1 is an interaction view of a communication path between a plurality of patrons, a plurality of athletes, universities, and a processing system that utilizes repository and methods, according to one embodiment.

FIG. 2 is an interaction view of a communication path between the plurality of patrons, the universities, athletes, and the various modules of the direct payment system, according to one embodiment.

FIG. 3 is a schematic block diagram illustrating a compensation transfer module of the direct payment system of FIGS. 1 & 2, according to one embodiment.

FIG. 4 is a schematic block diagram illustrating a NFT creation module of the direct payment system of FIGS. 1 & 2, according to one embodiment.

FIG. 5 is a schematic block diagram illustrating a compliance information module of the direct payment system of FIGS. 1 & 2, according to one embodiment.

FIG. 6 is a schematic block diagram illustrating an activity module of the direct payment system of FIGS. 1 & 2, according to one embodiment.

FIG. 7 is a schematic block diagram illustrating a blockchain transfer module of the direct payment system of FIGS. 1 & 2, according to one embodiment.

FIG. 8 is a schematic block diagram illustrating an alternative embodiment of the direct payment system wherein a bid module and a monetization module are used to compensate the athlete and transfer a monetization consideration to the patron, according to one embodiment.

FIG. 9 is a schematic block diagram illustrating the bid module of the direct payment system of FIG. 8, according to one embodiment.

FIG. 10 is a schematic block diagram illustrating the monetization consideration module of the direct payment system of FIG. 8, according to one embodiment.

FIG. 11 is a process flow diagram in which a non-fungible token is created according to parameters, league rules, and restrictions, according to one embodiment of the direct payment system of FIGS. 1-10.

FIG. 12 is a process flow diagram in which the various features of the direct payment system are described, according to one embodiment of the direct payment system of FIGS. 1-10.

FIG. 13 is a process flow diagram illustrating an alternative embodiment of the direct payment system in which a bidding module is implemented, according to one embodiment of the direct payment system of FIGS. 1-10.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

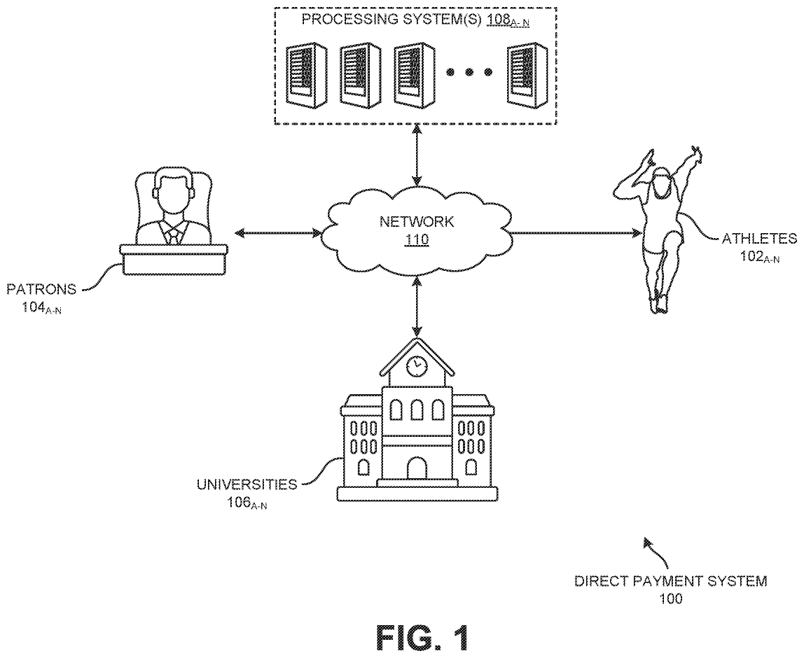

FIG. 1 is an interaction view of a direct payment system 100 comprising a communication path between a network 110 and a plurality of patrons 104A-N, a plurality of athletes 102A-N, universities 106A-N, and a processing system 108A-N, according to one embodiment. FIG. 1 illustrates athletes 102A-N, patrons 104A-N, universities 106A-N, processing systems 108A-N, and a network 110. The athletes 102A-N may be college athletes participating in sports sanctioned by the National Collegiate Athletic Association (NCAA), the National Association of Intercollegiate Athletics (NAIA), the National Junior College Athletic Association (NJCAA), the National Christian College Athletic Association (NCCAA), United States Collegiate Athletic Association (USCAA), and/or any other post high school level league.

The patrons 104A-N may be anyone who wishes to transfer a compensation 302 the athlete 102 for a non-fungible token 422 and/or a monetization compensation 1002. The universities 106A-N may be any post-secondary academic institution which sanction the athletes 102A-N participation in sports. The processing system 108A-N may be computing devices capable of processing artificial intelligence operations and performing the various operations of the various modules. The network 110 may be a wide area network, a local area network, a metropolitan area network, a wireless network, a campus network, a personal area network, a peer-to-peer network, a cloud network a virtual private network, a intranet, an extranet, or any other network that enables the processing system(s) 108A-N to communicate with athletes 102A-N, the patrons 104A-N, and the universities 106A-N.

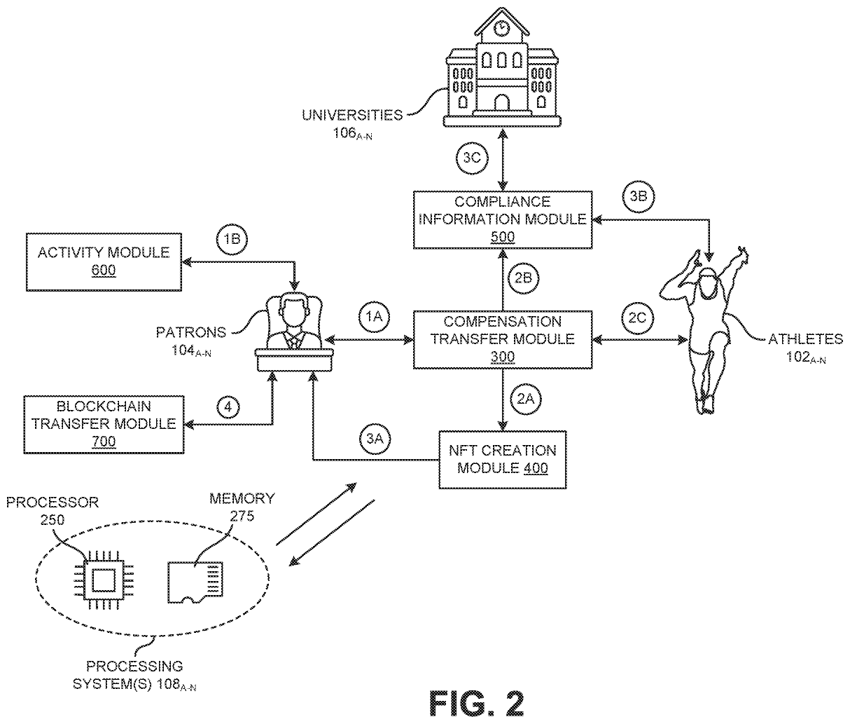

FIG. 2 is an interaction view of a communication path between the patrons 104A-N, the universities 106A-N, the athletes 102A-N, and the various modules of the direct payment system 100, according to one embodiment. FIG. 2 shows the athletes 102, the patrons 104, the universities 106, the processing systems 108 comprising a processor 250 and a memory 275, a compensation transfer module 300, a NFT creation module 400, a compliance information module 500, an activity module 600, a blockchain transfer module 700, and various orders of operation.

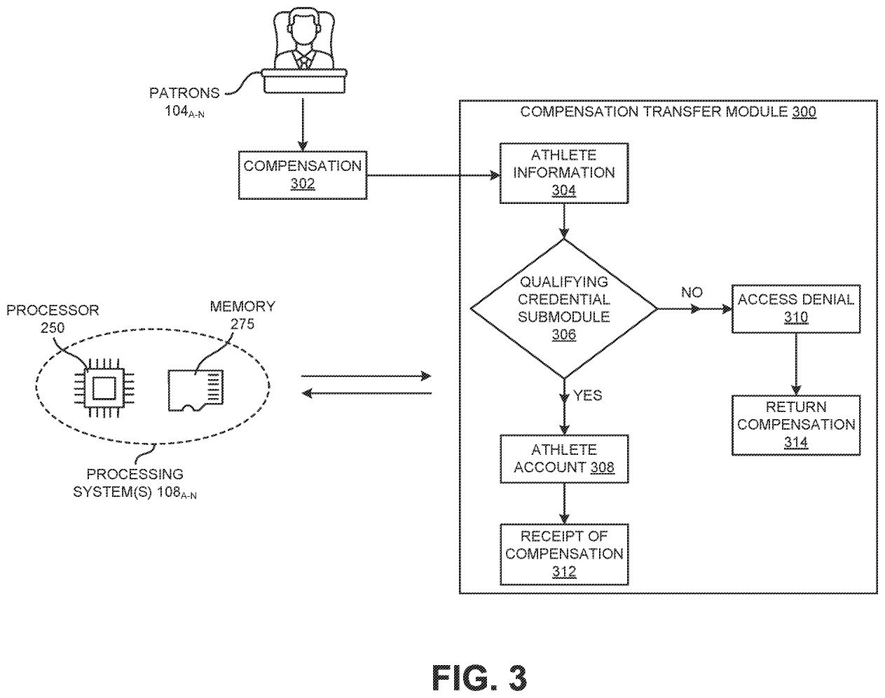

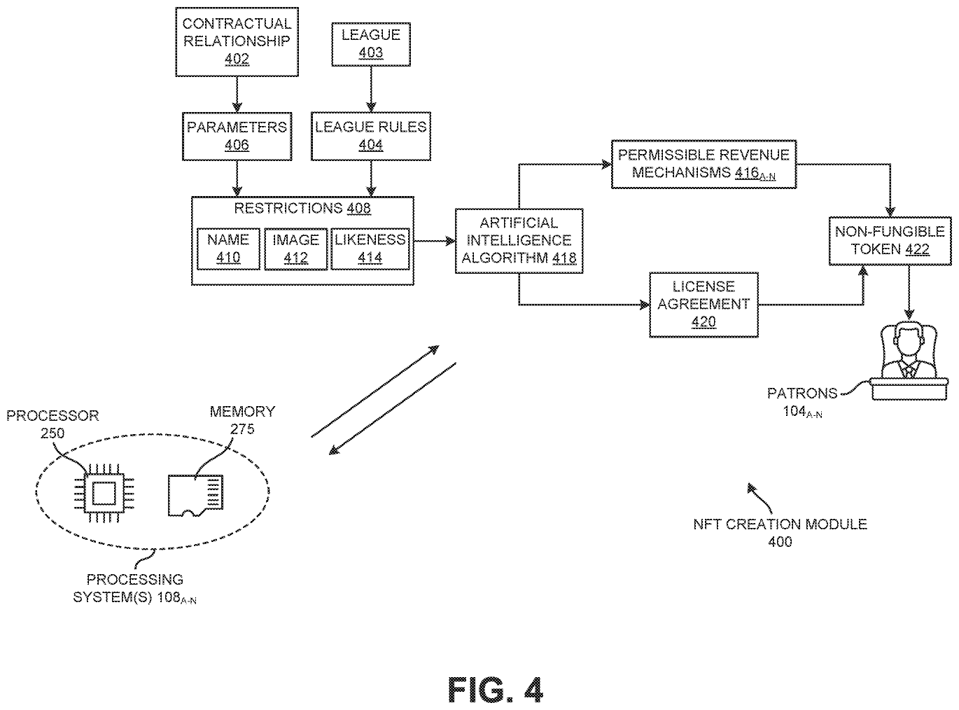

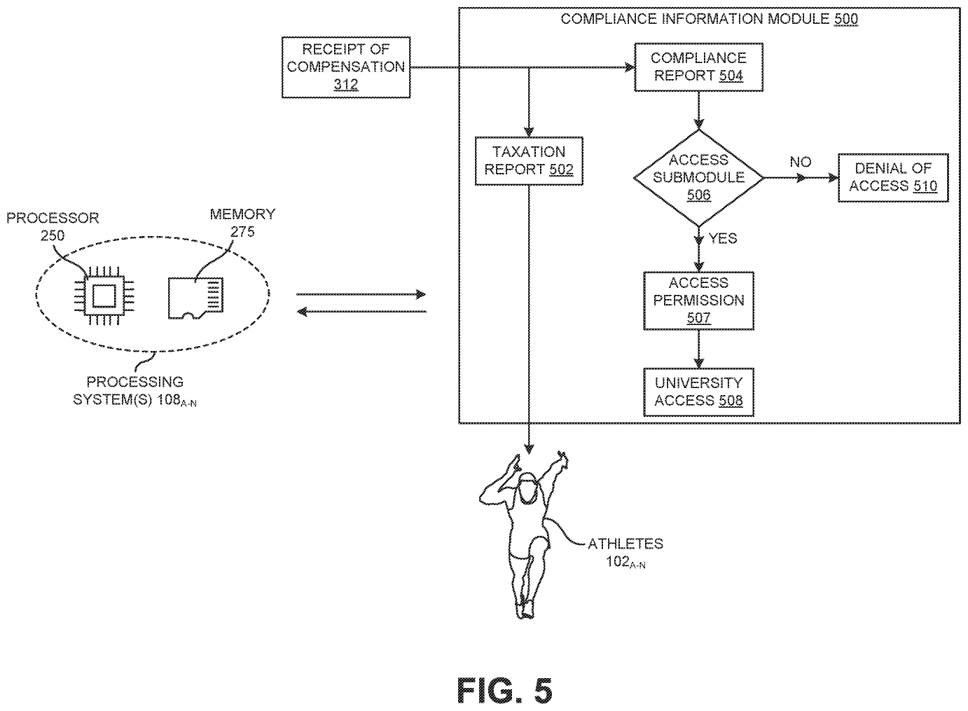

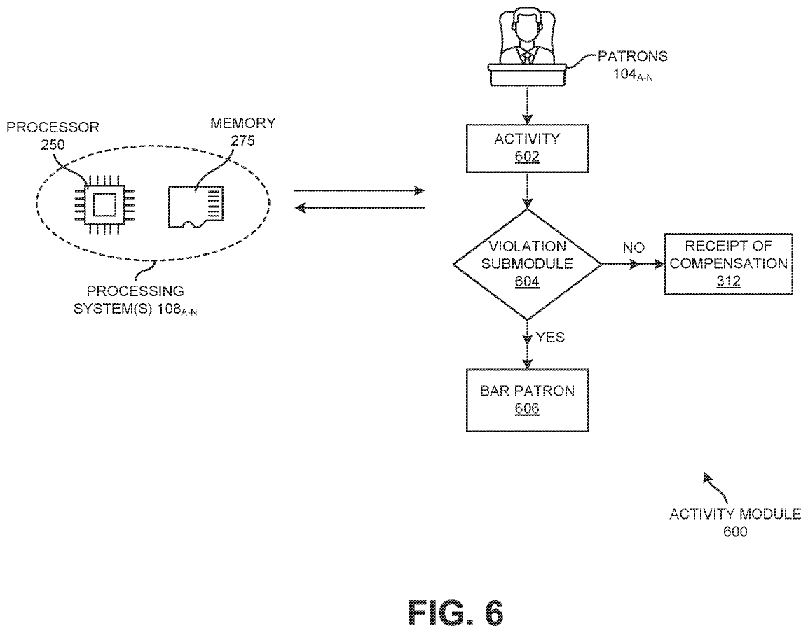

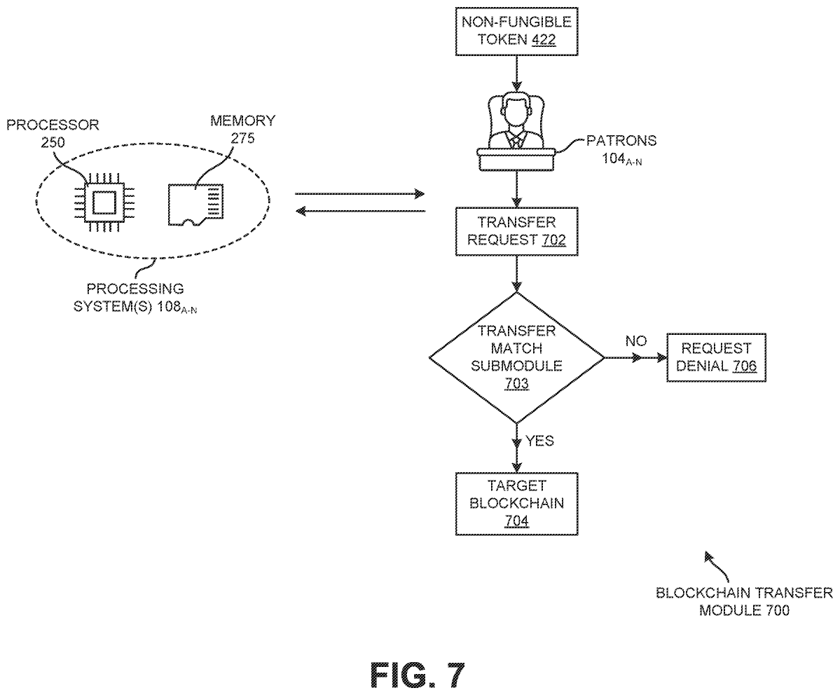

The compensation transfer module 300 may be a component of the direct payment system 100 that facilitates the transfer of a compensation 302 from the patron 104 to the athlete 102, as shown in FIG. 3. The NFT creation module 400 may be a component of the direct payment system 100 which utilizes an artificial intelligence algorithm 418 to create an NFT, as shown in FIG. 4. The compliance information module 500 may be a component of the direct payment system 100 which may generate a compliance report 504 specific to the athlete wherein one or more of a payment amount, a patron information, a timestamp, and at least one athlete information 304 is accessible to the university and may provide the university 106 the compliance report 504, as shown in FIG. 5. The activity module 600 may be a component of the direct payment system 100 in which an activity 602 of a patron 104 is evaluated for a violation, as shown in FIG. 6. The blockchain transfer module 700 may be a component of the direct payment system 100 which facilitates a transfer request 702 of a patron 104, as shown in FIG. 7. The orders of operation may be interchangeable and determined based upon various factors including network 110 availability, data size, user preferences, and/or errors in processing.

As shown in FIG. 2, the processing system(s) 108 facilitates communication and/or data transfer between the patron 104, the athlete 102, the university 106 and the various modules. At step 1A, the patron 104 may communicate with the compensation transfer module 300. At step 1B, the patron 104 may be assessed by the activity module 600. At step 2A, the compensation transfer module 300 may communicate with the NFT creation module 400. At step 2B, which may happen simultaneously with step 2A, the compensation transfer module 300 may communicate with the compliance information module 500. At step 2C, which may happen simultaneously with steps 2A and 2B, the compensation transfer module 300 may communicate with the athlete 102.

At step 3A, the NFT creation module 400 may communicate with the patron 104. At step 3B, which may happen simultaneously with step 3A, the compliance information module 500 may communicate with the athlete 102. At step 3C, which may happen simultaneously with steps 3A and 3B, the compliance information module 500 may communicate with the university 106. At step 4, the patron 104 may communicate with the blockchain transfer module 700.

FIG. 3 is a schematic block diagram illustrating a compensation transfer module 300 of the direct payment system 100 of FIGS. 1 & 2, according to one embodiment. FIG. 3 shows the patron 104, the processing systems 108 comprising the processor 250 and a memory 275, a compensation 302, an athlete information 304, a qualifying credential submodule 306, an athlete account 308, a denial of access 310, a receipt of compensation 312, and a return compensation 314.

The compensation 302 may be monetary, goods, and/or anything else of value. The athlete information 304 may be a personal information, email address, phone number, school identification number, and/or other means of identification. The qualifying credential submodule 306 may be an operational submodule that assess if the athlete information 304 matches that of a qualifying credential contained within the memory 275 which may then allow the direct payment system 100 to confirm that the athlete 102 targeted by the patron 104 is actually the individual the patron 104 intends to transfer the compensation 302 to and that the athlete 102 is associated with at least one of the universities 106A-N. The athlete account 308 may be an online account that is automatically created for the athlete 102 by the direct payment system 100 after the qualifying credential submodule 306 has confirmed the athlete information 304 is a qualifying credential. The denial of access 310 may be issued by the qualifying credential submodule 306 in the compensation transfer module 300 if the athlete information 304 is not a qualifying credential, which may result in the athlete 102 being denied from accessing the compensation 302 and the direct payment system 100. The compensation return 314 may be where the compensation 302 transferred by the patron 104 into the direct payment system 100 is transferred back to the patron 104 because the athlete 102 was denied access 310 to the direct payment system 100.

As shown in FIG. 3, the patron 104 may transfer the compensation 302 to the athlete 102 via the processor 250 and memory 275 of the processing system 108. First, the patron 104 may transfer the compensation 302 to the compensation transfer module 300 wherein the qualifying credential submodule 306 of the compensation transfer module 300 may determine if an information of the athlete 102 is a qualifying credential wherein access of the athlete 102 is granted if the information of the athlete 102 is a qualifying credential. The direct payment system 100 may create an athlete account 308 for the athlete 102 if the qualifying credential submodule 306 confirms the at least one information 304 of the athlete 102 is at least one qualifying credential. The athlete 102 may access the direct payment system 100 after the athlete account creation 308. After the athlete account 308 is created the receipt of compensation 312 may commence wherein the athlete 102 may receive the compensation 302 in the athlete account 308. If the qualifying credential submodule 306 determines that athlete information 304 is not a qualifying credential, the athlete 102 is given an access denial 310 and is not given permission to the receipt of compensation 312 and instead the compensation is returned 314 to the patron 104.

FIG. 4 is a schematic block diagram illustrating a NFT creation module 400 of the direct payment system 100 of FIGS. 1 & 2, according to one embodiment. FIG. 4 shows the patron 104, the processing systems 108 comprising the processor 250 and a memory 275, a contractual relationship 402, a league 403, a league rule(s) 404, a parameter(s) 406, a restriction(s) 408, a name 410, an image 412, a likeness 414, an artificial intelligence algorithm 418, a permissible revenue mechanism(s) 416A-N, a license agreement 420, and a non-fungible token 422.

The contractual relationship 402 may be a national letter of intent, an athletic agreement, a scholarship offer, a non-compete agreement, a student code of conduct, an athlete code of conduct, an athletic contract, an enrollment agreement, a financial agreement, a Family Educational Rights and Privacy Act (FERPA) agreement, and/or a health and medical agreement. The league 403 may be the National Collegiate Athletic Association (NCAA), the National Association of Intercollegiate Athletics (NAIA), the National Junior College Athletic Association (NJCAA), the National Christian College Athletic Association (NCCAA), United States Collegiate Athletic Association (USCAA), and/or any other post high school level league. Furthermore, the league 403 may comprise any of the sub conferences with the league 403. The league rule(s) 404 may be any rules associated with the league 403. The parameter(s) 406 may be any relevant term agreed upon by the university 106 and the athlete 102 within the contractual relationship 402.

The restriction(s) 408 may be the combined limitations to the athlete's 102 ability to receive a compensation 302. The name 410 may refer to the use of the athlete's 102 given name, nickname, and/or alias in commercial ventures, such as advertising, product endorsements, merchandise, sponsorships, or any other commercial activity that seeks to capitalize on the individual's reputation or popularity. The image 412 may refer to the use of the athlete's image, such as photographs, videos, or any visual representation, for commercial purposes. The likeness 414 may refer to the use of an individual's distinct characteristics, attributes, or identifiable features for commercial purposes. The artificial intelligence algorithm 418 may be a supervised Learning model, an unsupervised learning model, reinforcement learning model, a natural language processing model, a computer vision model, a genetic algorithm model, an expert system model, a fuzzy logic model, and/or a bayesian network model.

The permissible revenue mechanism(s) 416A-N may be one or more forms of revenue an athlete may receive based upon the restrictions 408. The license agreement 420 may be a legal contract between the patron 104 and the athlete 102 that may grant the patron 104 permission to use, access, and/or utilize certain rights and/or properties in the non-fungible token 422 owned or controlled by the athlete 102. The license agreement 420 may outline the terms and conditions under which the patron 104 may use the non-fungible token 422. The non-fungible token (“NFT”) 422 may be a digital asset that represents unique items or pieces of content on a blockchain and may be a digital art NFT, a collectibles NFT, virtual real estate NFT, a domain names NFT, a gaming NFT, a virtual goods NFT, a event ticket NFT, and/or a virtual reality NFT.

As shown in FIG. 4, the processor 250 and memory 275 of the processing system 108 input information into the artificial intelligence algorithm 418 to produce a non-fungible token 422 which is sent to the patron 104. First, the NFT creation module 400 identifies the set of parameters 406 associated with the contractual relationship 402 between the athlete 102 and the university 106. Next, the NFT creation module 400 associates the set of restrictions 408 to monetization of at least one of a name 410, an image 412 and a likeness 414 of the athlete 102 based on the set of parameters 406 associated with the contractual relationship 402 between the athlete 102 and the university 106. The NFT creation module 400 then determines a set of rules 404 associated with a league 403 in which the university 106 participates with respect to compensation 302 of the athlete 102.

Next, the NFT creation module 400 may automatically identify the set of permissible revenue mechanism(s) 416A-N available to the athlete 102 within the set of rules 404 of the league 403 and the set of restrictions 408 with respect to the contractual relationship 402 between the athlete 102 and the university 106. Next, the NFT creation module 400 may form a license agreement in a variety of permutations based on artificial intelligence algorithm 418 that analyzes at least one of a popularity of the athlete 102, a skill level of the athlete 102, a popularity of the university 106, a popularity of the intercollegiate sports team, a popularity of the league 403, a probabilistic playing career duration of the athlete 102, and potential sponsorship avenues likely available to the athlete 102 in a present time and a foreseeable future. The NFT creation module 400 may generate a non-fungible token 422 which may automatically encapsulate at least a portion of the set of permissible revenue mechanism(s) 416A-N along with the license agreement 420.

The NFT creation module 400 of the direct payment system may then permit the patron 104 to compensate the athlete 102 pursuant to the license agreement 420 by purchasing the non-fungible token 422 along with a set of privileges of ownership of the non-fungible token 422 along with a set of rights licensed from the athlete 102 to the patron 104. The non-fungible token 422 may include at least one identification property which enables a patron 104 to identify the athlete 102 associated with the non-fungible token 422. The NFT creation module 400 may then transfer the non-fungible token 422 to the patron 104.

FIG. 5 is a schematic block diagram illustrating a compliance information module 500 of the direct payment system 100 of FIGS. 1 & 2, according to one embodiment. FIG. 5 shows the processing systems 108 comprising the processor 250 and a memory 275, the athlete 102, the receipt of compensation 312, a taxation report 502, a compliance report 504, an access submodule 506, a access permission 507, a university access 508, and a denial of access 510. The taxation report 502 may be a review or statement that is personalized to the athlete 102 detailing an income received from the patron 104 and a tax liability of the athlete 102. The taxation report 502 may include an income tax report, a sales tax report, a value added tax report, a payroll tax report, a goods and services tax report, a withholding tax report, and/or a property tax report. The taxation report 502 may be a form 1099-misc, a form 1099-INT, a form 1099-R, a form 1099-B, and/or a form 1099-K.

The compliance report 504 may be specific to the athlete 102 in which at least one of a payment amount, a patron information, a timestamp, and at least one athlete information 304 is accessible to the university 106. The payment amount may be a payment record detailing money and/or other compensation transferred from the patron 104 to the athlete 102. The timestamp may be a time record indicating when compensation was transferred from the patron 104 to the athlete 102, a time record indicating when the patron 104 received the non-fungible token 422, and/or a time record indicating when the athlete 102 last accessed the direct payment system 100.

The access submodule 506 may be a operational component wherein a attribute and/or a information of the university 106 may be assessed for a qualifying credential to determine if the university 106 has access permission 507 to access the compliance report 504 and that the university 106 seeking access is actually the university 106 and not another university 106 seeking access by mistake and/or as a bad faith actor. The access permission 507 may be issued by the access submodule 506 of the compliance information module 500 when the attribute and/or information assessed by the access submodule 506 matches a qualifying credential. The university access 508 may be a portal and/or data access interface that may allow the university 106 access to the compliance report 504 so the university 106 may assess the payment amount, the patron's information, the timestamp, and/or the athlete's information 304.

The university access 508 may also allow the university 106 to assess the athlete's 102 compliance with the parameters 406 of the contractual relationship 402 and league rules 404. The denial of access 510 may be an operation wherein the university 106 seeking access to the compliance report 504 is denied entry into the university access 508 because the access submodule 506 finds that the university 106 seeking access to the compliance report 504 is seeking the specific compliance report 504 by mistake and/or is a bad faith actor such a hacker, a malware, and/or a virus.

As shown in FIG. 5, the processor 250 and memory 275 of the processing system 108 notify the compliance information module 500 of the receipt of compensation 312. After the receipt of compensation 312, the compliance information module 500 may generate a taxation report 502 that is personalized to the athlete 102 detailing an income received from the patron 104 and a tax liability of the athlete 102. The taxation report 502 may be accessible to the athlete 102 within the athlete account 308. Furthermore, after the receipt of compensation 312, the compliance information module 500 may generate a compliance report 504 specific to the athlete 102 in which at least one of the payment amount, the patron's information, the timestamp, and the athlete's information 304 is accessible to the university 106.

The compliance report 504 may be accessible to both the athlete 102 and the university 106. In order for the university 106 to access the compliance report 504, they must receive the access permission 507 which ensures that the correct university 106 is seeking access to the correct compliance report 504 and may also ensure bad faith actors are barred from accessing the compliance report 504. The access submodule 506 of the compliance information module 500 may assess the university 106 for a qualifying credential to determine if the access permission 507 should be issued to the university 106 which may permit the university 106 to access the compliance report 504. If the access permission 507 is not present, the denial of access 510 may be issued. The denial of access 510 may be a message directly to the university 106, an error message, and/or a popup which may notify the university 106 that they cannot access the compliance report 504.

FIG. 6 is a schematic block diagram illustrating an activity module 600 of the direct payment system 100 of FIGS. 1 & 2, according to one embodiment. FIG. 6 shows the patron 104, the processing systems 108 comprising the processor 250 and a memory 275, the receipt of compensation, 312, an activity 602, a violation submodule 604, and a barring 606. The activity 602 may be a bid, an attempt to transfer compensation 302, a communication, and/or a third party activity. The violation submodule 604 may be a module that monitors the patron's 104 activity 602 to ensure the activity 602 complies with laws, ordinances, and/or policies of the direct payment system 100. The barring 606 of the patron 104 may be a one-time barring 606 of the patron 104, a suspension of the patron 104, a permanent banishment of the patron 104 and/or a modification of permissible activities within the direct payment system 100.

As shown in FIG. 6, the processor 250 and memory 275 of the processing system 108 may contain the violation submodule 604 of the activity module 600 which may analyze an activity 602 of the patron 104 for a violation wherein the violation may result in the activity module 600 barring 606 the patron 104 from compensating the athlete 102. The activity 602 of the patron 104 is assessed by the violation submodule 604. If the violation submodule 604 of the activity module 600 determines the patron's 104 activity 602 is a violation, then the patron 104 may be barred 606. If the patron's 104 activity 602 is not a violation, then the patron 104 may transfer compensation to the athlete 102 and the athlete 102 may receive the compensation 312.

FIG. 7 is a schematic block diagram illustrating a blockchain transfer module 700 of the direct payment system 100 of FIGS. 1 & 2, according to one embodiment. FIG. 7 shows the patron 104, the processing systems 108 comprising the processor 250 and a memory 275, the non-fungible token 422, a transfer request 702, a transfer match submodule 703, a target blockchain 704, and a request denial 706. The transfer request 702 may be a communication from the patron 104 wherein the patron 104 wishes to move the non-fungible token 422 from its original blockchain to a target blockchain 704. The transfer submodule 703 may be an operation component that determines if the non fungible token 422 can be transferred to the target blockchain 704.

The target blockchain 704 may be a blockchain different than the blockchain the non-fungible token 422 is originally issued on including Ethereum, Binance Smart Chain, Flow, Solana, Polygon, Tezos, Cardano, Wax, and/or EOS. The transfer match submodule 703 of the blockchain transfer module of the direct payment system may automatically match a transfer request 702 of the non-fungible token 422 from the patron 104 to a target blockchain 704, wherein the non-fungible token 422 cannot be transferred unless the transfer request 702 matches the target blockchain 704. The request denial 706 may be wherein the transfer match submodule 703 determines that the non-fungible token 422 cannot be transferred to the target blockchain 704.

As shown in FIG. 7, the processor 250 and memory 275 of the processing system 108 contain the blockchain transfer module 700 wherein after the patron 104 receives the non-fungible token, the patron 104 may submit a transfer request 702 to the transfer match submodule 703 of the blockchain transfer module 700. After submitting the transfer request 702, the transfer match submodule 703 may determine if the target blockchain 704 is a permissible blockchain to transfer the non-fungible token 422 to. Various factors may affect the transfer of the non-fungible token 422 from one blockchain to another including blockchain compatibility, bridge infrastructure, decentralization applications and/or platforms, tokenomics and fees, smart contract audits, security audits, blockchain speed and scalability, and/or interoperability standards. If the target blockchain 704 is not permissible to transfer the non-fungible token 422 to, then a request denial 706 will be issued, and the non-fungible token 422 will remain on the blockchain it was issued on. If the target blockchain 704 is a permissible blockchain to transfer the non-fungible token 422 to, then the transfer match submodule may automatically transfer the non-fungible token 422 to the target blockchain 704.

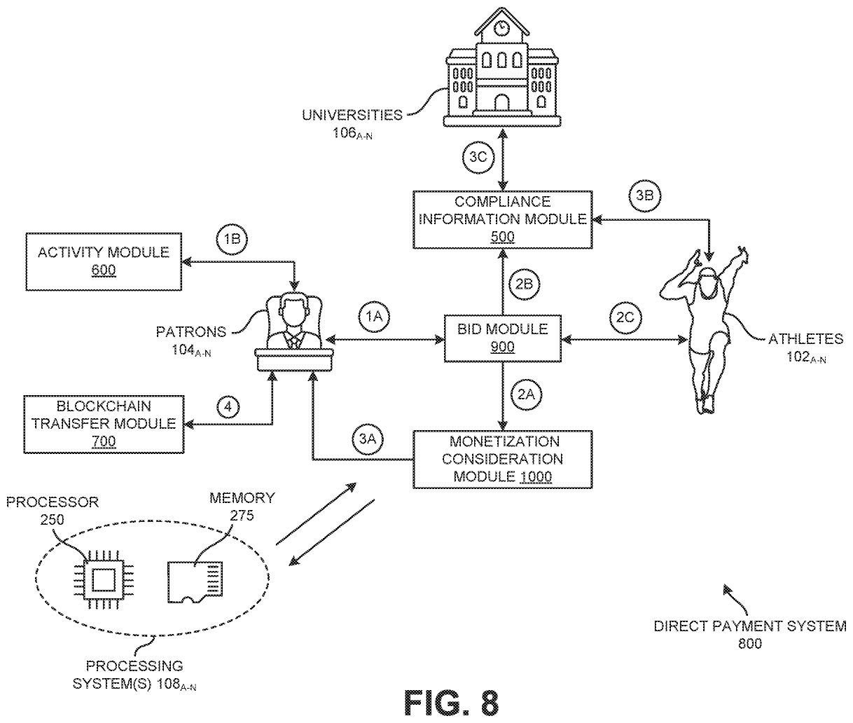

FIG. 8 is a schematic block diagram illustrating an alternative embodiment of the direct payment system 800 wherein a bid module 900 and a monetization module 1000 are used to compensate the athlete 102 and transfer a monetization consideration 1002 to the patron 104, according to one embodiment. FIG. 8 shows the athletes 102A-N, the patrons 104A-N, the universities 106A-N, the processing systems 108 comprising a processor 250 and a memory 275, a bid module 900, a monetization consideration module 1000, the compliance information module 500, the activity module 600, a blockchain transfer module 700, and various orders of operation.

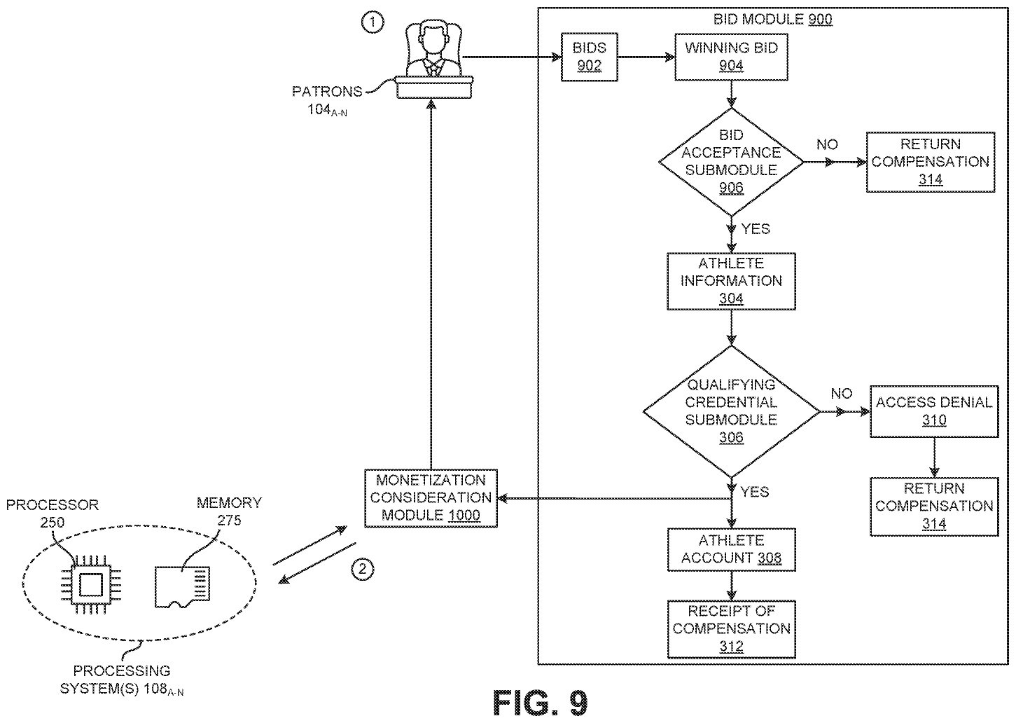

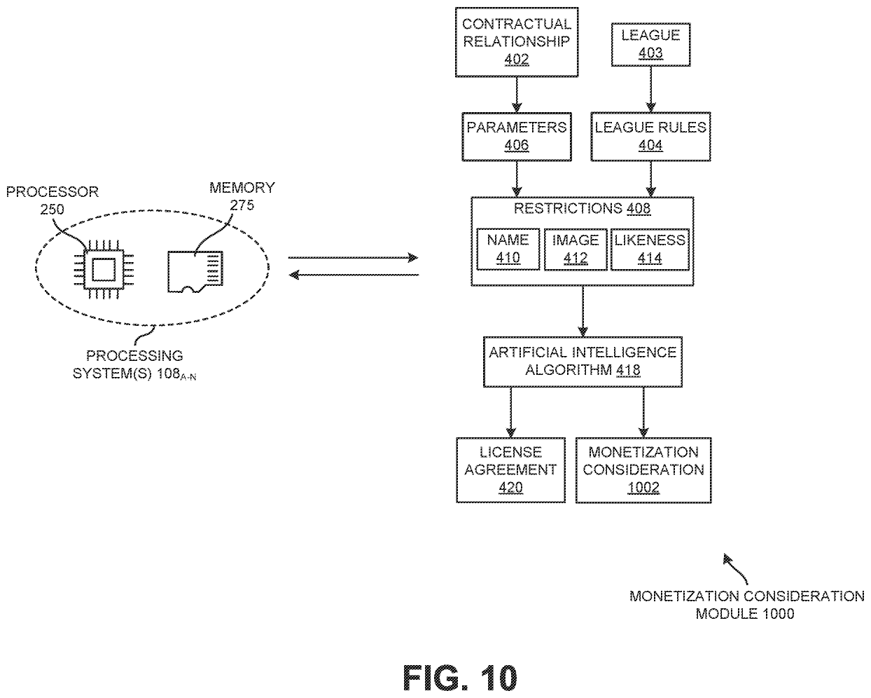

The bid module 900 may be a component of the direct payment system 800 that facilitates the transfer of a compensation 302 from the patron 104 to the athlete 102, as shown in FIG. 9. The monetization consideration module 1000 may be a component of the direct payment system 800 which utilizes an artificial intelligence algorithm 418 to determine a monetization consideration 1002 and a license agreement 420, as shown in FIG. 10. The compliance information module 500 may be a component of the direct payment system 800 which may generate a compliance report 504 viewable by the university 106 which is specific to the athlete and details at least one of a payment amount, a patron information, a timestamp, and at least one athlete information 304, as shown in FIG. 5. The activity module 600 may be a component of the direct payment system 800 in which an activity 602 of a patron 104 is evaluated for a violation, as shown in FIG. 6. The blockchain transfer module 700 may be a component of the direct payment system 800 which facilitates a transfer request 702 of a patron 104, as shown in FIG. 7. The orders of operation may be interchangeable and determined based upon various factors including network 110 availability, data size, user preferences, and/or errors in processing.

As shown in FIG. 8, the processing system(s) 108 facilitates communication and/or data transfer between the patron 104, the athlete 102, the university 106 and the various modules. At step 1A, the patron 104 may communicate with the bid module 900. At step 1B, the patron 104 may be assessed by the activity module 600. At step 2A, the bid module 900 may communicate with the monetization consideration module 1000. At step 2B, which may happen simultaneously with step 2A, the bid module 900 may communicate with the compliance information module 500. At step 2C, which may happen simultaneously with steps 2A and 2B, the bid module 900 may communicate with the athlete 102.

At step 3A, the monetization consideration module 1000 may communicate with the patron 104. At step 3B, which may happen simultaneously with step 3A, the compliance information module 500 may communicate with the athlete 102. At step 3C, which may happen simultaneously with steps 3A and 3B, the compliance information module 500 may communicate with the university 106. At step 4, the patron 104 may communicate with the blockchain transfer module 700.

FIG. 9 is a schematic block diagram illustrating a bid module of the direct payment system 800 of FIG. 8, according to one embodiment. FIG. 9 shows the patron 104, the processing systems 108 comprising the processor 250 and a memory 275, the athlete information 304, the qualifying credential submodule 306, the athlete account 308, the receipt of compensation 312, the return of compensation 314, a bid(s) 902, a winning bid 904, a bid acceptance submodule 906, and the monetization consideration module 1000. The bid 902 may be anything of legal monetary value and may be submitted to the bid module 900 by the patron 104. The winning bid 904 may be the bid 902 with the highest monetary value and/or the bid 902 that is most desirable to the athlete 102. The bid acceptance submodule 904 may be a submodule that selects the winning bid 902 based upon predetermined parameters determined by the athlete 102.

As shown in FIG. 9, the processor 250 and memory 275 of the processing system 108 contain the bid module 900 which may process the set of bids 902 for the monetization consideration 1002 from a plurality of patrons 104A-N, wherein the set of bids 902 is a compensation 302 that is offered for the at least one permissible revenue mechanism(s) 416A-N. The bid module 900 may determine which is the winning bid 904 of the set of bids 902 from the plurality of patrons 104A-N. The bid acceptance submodule 906 may automatically accept and/or deny the winning bid 904 on behalf of the athlete 102. The athlete 102 may manually determine whether to accept the winning bid 904 or not. The bid module 900 may transfer the monetization consideration 1002 to the patron 104 in exchange for the compensation 302 if the winning bid 904 is accepted 906 by the athlete 102. If the bid 902 is not accepted 906 by the athlete 102 and/or the bid acceptance submodule 906, the winning bid 904 may be a returned compensation 314 in which the bid is returned to the patron 104.

After receiving the set of bids 902, the qualifying credential submodule 306 of the bid module 900 of direct payment system 800 may determine that an athlete 102 is associated with an intercollegiate sports team of a university 106 by matching at least one athlete information 304 to at least one qualifying credential. The bid module 900 of direct payment system 800 may create an athlete account 308 for the athlete 102 if the qualifying credential submodule 306 confirms the at least one athlete information 304 is at least one qualifying credential. The athlete 102 may access the direct payment system 800 after the athlete account creation 308. After the athlete account 308 is created, the athlete 102 may receive the compensation 302. If the qualifying credential submodule 306 determines athlete information 304 is not a qualifying credential, the athlete 102 is given an access denial 310 and is not given permission to the receipt of compensation 312 and instead the compensation is returned 314 to the patron 104.

FIG. 10 is a schematic block diagram illustrating the monetization consideration module 1000 of the direct payment system 800 of FIG. 8, according to one embodiment. FIG. 10 shows the processing systems 108 comprising the processor 250 and a memory 275, the contractual relationship 402, the league 403, the league rule(s) 404, the parameter(s) 406, the restriction(s) 408, the name 410, the image 412, the likeness 414, the artificial intelligence algorithm 418, the license agreement 420, and a monetization consideration 1002. The monetization consideration 1002 may be a permissible consideration such as a non-fungible token 422, an autograph, a merchandise, an appearance, a spokesperson role, and/or any other consideration the athlete 102 may legally provide to the patron 104.

As shown in FIG. 10, the processor 250 and memory 275 of the processing system 108 contain the monetization consideration module 1000 which may identify the set of parameters 406 associated with the contractual relationship 402 between the athlete 102 and the university 106 using the processor 250 and the memory 275. The monetization consideration module 1000 may associate the set of restrictions 408 to monetization of at least one of the name 410, the image 412 and the likeness 414 of the athlete 102 based on the set of parameters 406 associated with the contractual relationship 402 between the athlete 102 and the university 106.

The monetization consideration module 1000 establishes at least one permissible revenue mechanism(s) 416A-N available to the athlete 102 within the set of rules 404 of the league 403 and the set of restrictions 408 with respect to the contractual relationship 402 between the athlete 102 and the university 106. The monetization consideration module 1000 derives a monetization consideration 1002 from at least one of the name 410, the image 412, and the likeness 414 of the athlete 102 based on the set of parameters 406 associated with the contractual relationship 402 between the athlete 102 and the university 106. The monetization consideration 1002 may be in the form of a non-fungible token 422 and may contain a set of privileges of ownership of the non-fungible token 422 along with a set of rights licensed from the athlete 102 to the patron 104.

The monetization consideration module 1000 may further form a license agreement 420 in a variety of permutations based on artificial intelligence algorithm 418 that analyzes at least one of a popularity of the athlete 102, a skill level of the athlete 102, a popularity of the university 106, a popularity of the intercollegiate sports team, a popularity of the league 403, a probabilistic playing career duration of the athlete 102, and potential sponsorship avenues likely available to the athlete 102 in a present time and a foreseeable future.

The method may permit the patron 104 to compensate the athlete 102 pursuant to the license agreement by purchasing the monetization consideration 1002 in the form of a non-fungible token 422 along with a set of privileges of ownership of the non-fungible token 422 along with a set of rights licensed from the athlete 102 to the patron 104. The method may include wherein the non-fungible token 422 automatically encapsulates at least a portion of the set of permissible revenue mechanism(s) 416A-N along with the license agreement

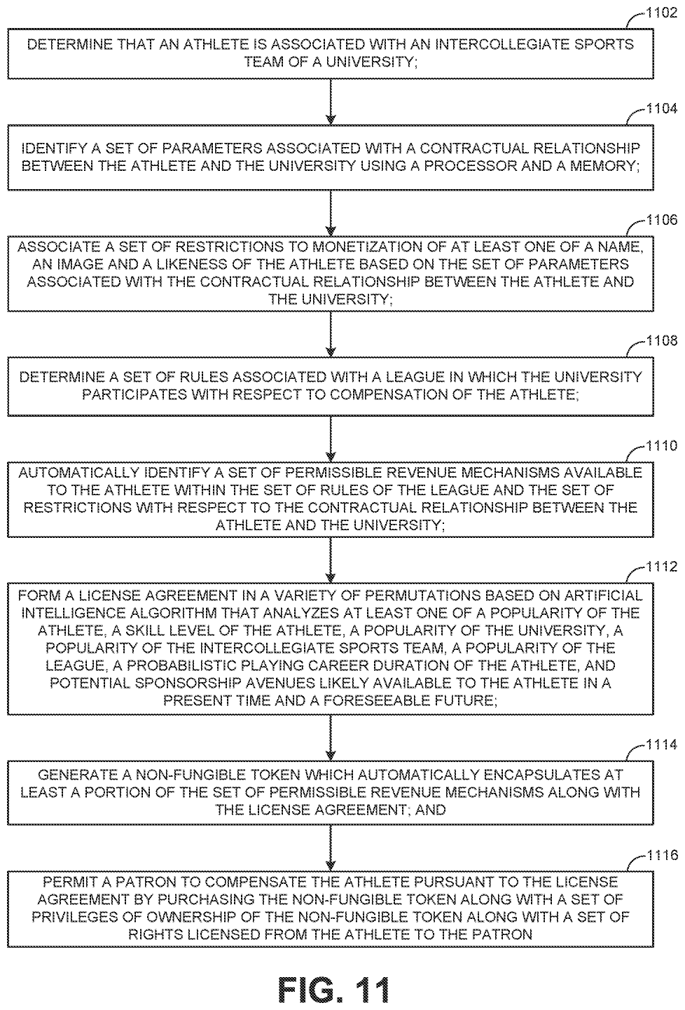

FIG. 11 is a process flow diagram in which a non-fungible token 422 is created according to parameters 406, league rules 404, and restrictions 408, according to one embodiment of the direct payment system of FIGS. 1-10. In operation 1102, it may be determined that an athlete is associated with an intercollegiate sports team of a university. In operation 1104, a set of parameters associated with a contractual relationship between the athlete and the university may be identified using a processor and a memory. In operation 1106, a set of restrictions to monetization may be associated with at least one of a name, an image and a likeness of the athlete based on the set of parameters associated with the contractual relationship between the athlete and the university. In operation 1108, a set of rules associated with a league in which the university participates with respect to compensation of the athlete may be determined.

In operation 1110, a set of permissible revenue mechanisms available to the athlete within the set of rules of the league and the set of restrictions with respect to the contractual relationship between the athlete and the university may be automatically identified. In operation 1112, a license agreement may be formed in a variety of permutations based on artificial intelligence algorithm that analyzes at least one of a popularity of the athlete, a skill level of the athlete, a popularity of the university, a popularity of the intercollegiate sports team, a popularity of the league, a probabilistic playing career duration of the athlete, and potential sponsorship avenues likely available to the athlete in a present time and a foreseeable future. In operation 1114, a non-fungible token which automatically encapsulates at least a portion of the set of permissible revenue mechanisms along with the license agreement may be generated. In operation 1116, a patron 104 may be permitted to compensate the athlete pursuant to the license agreement by purchasing the non-fungible token along with a set of privileges of ownership of the non-fungible token along with a set of rights licensed from the athlete to the patron.

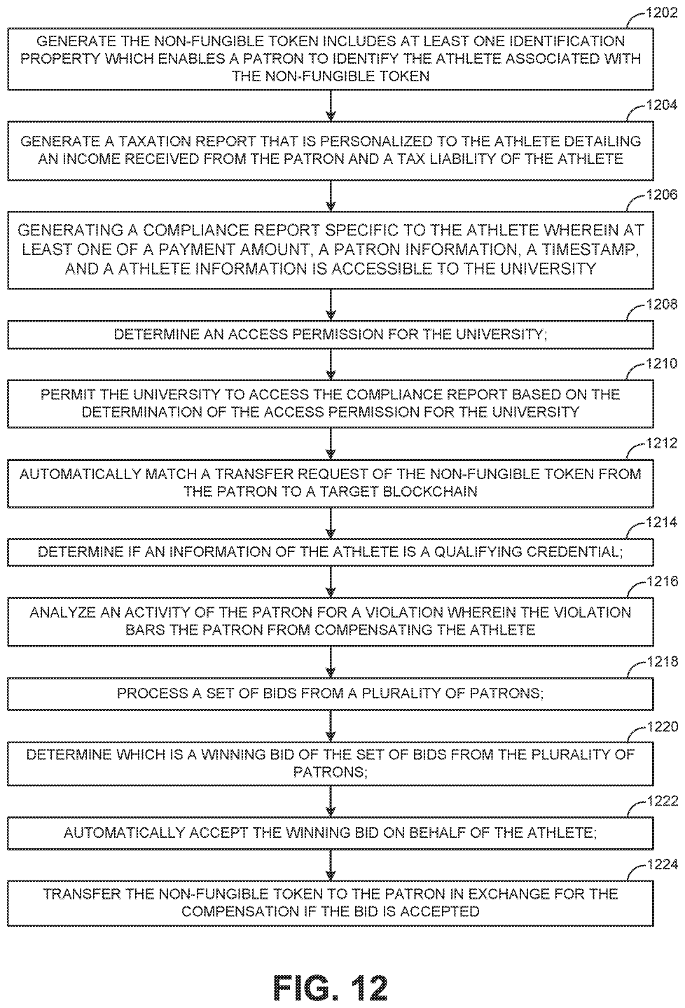

FIG. 12 is a process flow diagram in which the various features of the direct payment system are described, according to one embodiment of the direct payment system of FIGS. 1-10. In operation 1202, generation of the non-fungible token includes at least one identification property which enables a patron to identify the athlete associated with the non-fungible token. In operation 1204, a taxation report that is personalized to the athlete detailing an income received from the patron and a tax liability of the athlete is generated. In operation 1206, a compliance report specific to the athlete wherein at least one of a payment amount, a patron information, a timestamp, and at least one athlete information is accessible to the university may be generated. In operation 1208, an access permission for the university is determined.

In operation 1210, the university is permitted to access the compliance report based on the determination of the access permission for the university. In operation 1212, a transfer request of the non-fungible token from the patron may be automatically matched to a target blockchain. In operation 1214, it may be determined if an information of the athlete is a qualifying credential. In operation 1216, an activity of the patron may be analyzed for a violation wherein the violation bars the patron from compensating the athlete. In operation 1218, a set of bids from a plurality of patrons may be processed. In operation 1220, it may be determined which is a winning bid of the set of bids from the plurality of patrons. In operation 1222, the winning bid may be automatically accepted on behalf of the athlete. In operation 1224, the non-fungible token may be transferred to the patron in exchange for the compensation if the bid is accepted.

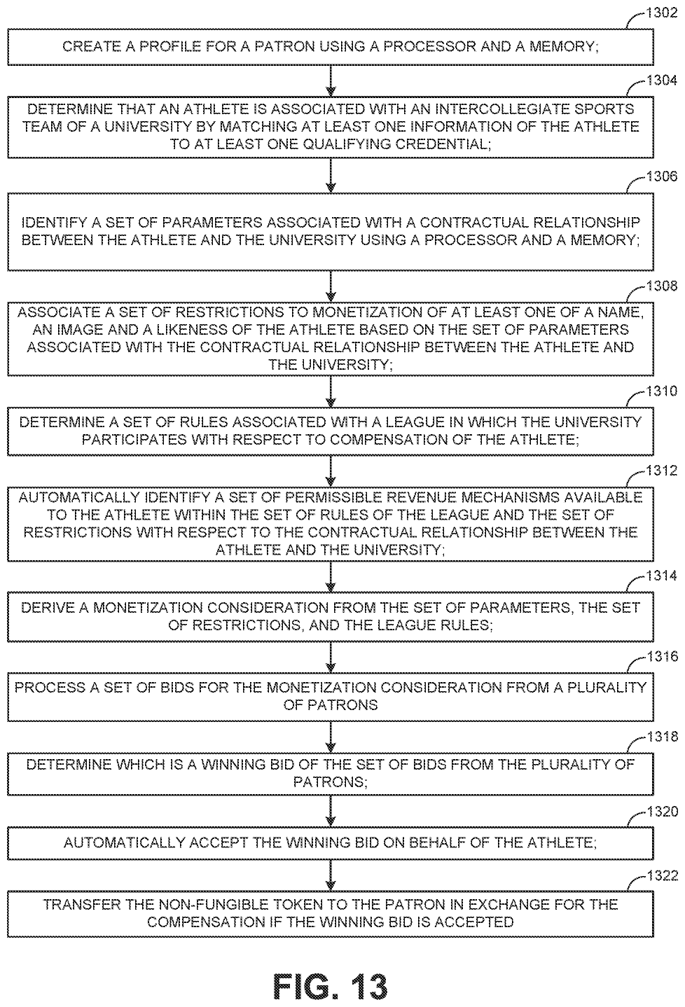

FIG. 13 is a process flow diagram illustrating an alternative embodiment of the direct payment system of FIGS. 1-10 in which a bidding module 900 is implemented, according to one embodiment of the direct payment system of FIGS. 1-10. In operation 1302, a profile for a patron may be created using a processor and a memory. In operation 1304, it may be determined that an athlete is associated with an intercollegiate sports team of a university by matching at least one information of the athlete to at least one qualifying credential. In operation 1306, a set of parameters associated with a contractual relationship between the athlete and the university may be identified using the processor and the memory.

In operation 1308, a set of restrictions to monetization of at least one of a name, an image and a likeness of the athlete based on the set of parameters may be associated with the contractual relationship between the athlete and the university. In operation 1310, determine a set of rules associated with a league in which the university participates with respect to compensation of the athlete may be determined. In operation 1312, a set of permissible revenue mechanisms available to the athlete within the set of rules of the league and the set of restrictions with respect to the contractual relationship between the athlete and the university may be automatically identified. In operation 1314, a monetization consideration may be derived from the set of parameters, the set of restrictions, and the league rules.

In operation 1316, a set of bids for the monetization consideration from a plurality of patrons may be processed. In operation 1318, a winning bid of the set of bids from the plurality of patrons may be determined. In operation 1320, the winning bid may be automatically accepted on behalf of the athlete. In operation 1322, the non-fungible token may be transferred to the patron in exchange for the compensation if the winning bid is accepted.

In yet another embodiment, a system may comprise a computing cluster having at least one of central processors and graphics processing units each having a processor and a memory. The system may further include a network and a plurality of submodules which may determine that an athlete 102 is associated with an intercollegiate sports team of a university 106 by assessing at least one information 304 of the athlete 102 for a qualifying credential 306. The system may identify a set of parameters 406 associated with a contractual relationship 402 between the athlete 102 and the university 106 using a processor and a memory. The system may associate a set of restrictions 408 to monetization of at least one of a name 410, an image 412 and a likeness 414 of the athlete 102 based on the set of parameters 406 associated with the contractual relationship 402 between the athlete 102 and the university 106. The system may then determine a set of rules 404 associated with a league 403 in which the university 106 participates with respect to compensation 302 of the athlete 102.

The system may automatically identify a set of permissible revenue mechanism(s) 416A-N available to the athlete 102 within the set of rules 404 of the league 403 and the set of restrictions 408 with respect to the contractual relationship 402 between the athlete 102 and the university 106. The system may form a license agreement 420 in a variety of permutations based on artificial intelligence algorithm 418 that analyzes at least one of a popularity of the athlete 102, a skill level of the athlete 102, a popularity of the university 106, a popularity of the intercollegiate sports team, a popularity of the league 403, a probabilistic playing career duration of the athlete 102, and potential sponsorship avenues likely available to the athlete 102 in a present time and a foreseeable future. The system may then generate a non-fungible token 422 which automatically encapsulates at least a portion of the set of permissible revenue mechanism(s) 416A-N along with the license agreement.

The system may permit a patron 104 to compensate the athlete 102 pursuant to the license agreement by purchasing the non-fungible token 422 along with a set of privileges of ownership of the non-fungible token 422 along with a set of rights licensed from the athlete 102 to the patron 104. The system may generate a taxation report 502 that is personalized to the athlete 102 which may detail the athlete's 102 tax liability for one or more jurisdictions. The system may form a compliance report 504 specific to the athlete 102 in which at least one of a payment amount, a patron information, a timestamp, and an athlete information is made accessible to the university 106. Last, the system may determine an access permission 507 for the university 106 and may permit the university 106 to access the compliance report 504 based on the determination of the access permission 507 for the university 106.

Changes to name, image, and likeness laws, ordinances, and collegiate rules have entirely changed the landscape of college athletics. Previously, a patron compensating a college athlete could result in harsh punishment for both the athlete and the university, and perhaps even lead to criminal punishment. Athletes faced loss of eligibility, loss of scholarship, and expulsion from their university. The universities faced fines, win and title vacations, loss of eligibility, postseason bans, and/or coaching/personnel suspensions.

Now, athletes may be compensated for various activities including endorsements, social media influencing, autograph signings, merchandising, instruction, content creation, personal appearances, speaking engagements, and/or broadcasting. Athletes may also be compensated by university boosters who compile funds to entice athlete's to attend their university. Although these revenue mechanisms are useful for athletes, prior to the embodiments for FIGS. 1-13, there were no mechanisms for a patron to directly compensate their favorite athletes. Prior to the embodiments of FIGS. 1-13, patrons could either enter into time consuming deals for endorsements, social media influencing, autograph signings, merchandising, instruction, content creation, personal appearances, speaking engagements, and/or broadcasting or the patrons could donate to athletic booster funds intended to compile money to compensate athletes. Prior to the embodiments of FIGS. 1-13, athletes who attended smaller schools or played low profile sports had very few monetization options. Furthermore, prior to embodiments of FIGS. 1-13, universities struggled to monitor their athlete's compensation and thus struggled to ensure compliance to adherence of the athlete to tax laws and ordinances of a jurisdiction in which the athlete resides and to league rules. Additionally, prior to embodiments of FIGS. 1-13, athletes had no mechanism to monitor their own tax liability.

The embodiments of FIGS. 1-13 may remedy these issues. The embodiments of FIGS. 1-13 may enable patrons to easily compensate athletes without having to enter into time and energy consuming deals and contracts. The embodiments of FIGS. 1-13 may enable the transfer of compensation from a patron to an athlete and in return transfer a non-fungible token to the patron which may memorialize the transaction which may prove proper compliance. The embodiments of FIGS. 1-13 may enable athletes who are not high profile, do not attend large schools, and/or do not participate in high profile sports to be compensated, and may do so without the need to enter into a lengthy or exhaustive contract. The embodiments of FIGS. 1-13 may allow athletes to be compensated while allowing their universities to access reports to ensure they are complying with local ordinances, laws, and/or league and university rules. The embodiments of FIGS. 1-13 may allow the athlete to easily track their own monetary intake and liabilities, while ensuring they are fairly compensated. A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A method comprising:
determining that an athlete is associated with an intercollegiate sports team of a university;
identifying a set of parameters associated with a contractual relationship between the athlete and the university using a processor and a memory;
associating a set of restrictions to monetization of at least one of a name, an image and a likeness of the athlete based on the set of parameters associated with the contractual relationship between the athlete and the university;
determining a set of rules associated with a league in which the university participates with respect to compensation of the athlete;
automatically identifying a set of permissible revenue mechanisms available to the athlete within the set of rules of the league and the set of restrictions with respect to the contractual relationship between the athlete and the university;
forming a license agreement in a variety of permutations based on artificial intelligence algorithm that analyzes at least one of a popularity of the athlete, a skill level of the athlete, a popularity of the university, a popularity of the intercollegiate sports team, a popularity of the league, a probabilistic playing career duration of the athlete, and potential sponsorship avenues likely available to the athlete in a present time and a foreseeable future;
generating a non-fungible token which automatically encapsulates at least a portion of the set of permissible revenue mechanisms along with the license agreement; and
permitting a patron to compensate the athlete pursuant to the license agreement by purchasing the non-fungible token along with a set of privileges of ownership of the non-fungible token along with a set of rights licensed from the athlete to the patron.

2. The method of claim 1 further comprising:
generating the non-fungible token includes at least one identification property which enables a patron to identify the athlete associated with the non-fungible token.

3. The method of claim 2 further comprising:
generating a taxation report that is personalized to the athlete detailing an income received from the patron and a tax liability of the athlete.

4. The method of claim 3 further comprising:
generating a compliance report specific to the athlete wherein at least one of a payment amount, a patron information, a timestamp, and an athlete information is accessible to the university.

5. The method of claim 4 further comprising:
determining an access permission for the university; and
permitting the university to access the compliance report based on the determination of the access permission for the university.

6. The method of claim 5 further comprising:
automatically matching a transfer request of the non-fungible token from the patron to a target blockchain,
wherein the non-fungible token cannot be transferred unless the transfer request matches the target blockchain.

7. The method of claim 6 further comprising:
determining if an information of the athlete is a qualifying credential;
wherein access of an athlete is granted if the information of the athlete is the qualifying credential.

8. The method of claim 7 further comprising:
analyzing an activity of the patron for a violation wherein the violation bars the patron from compensating the athlete.

9. The method of claim 8 further comprising:
processing a set of bids from a plurality of patrons;
determining which is a winning bid of the set of bids from the plurality of patrons;
automatically accepting the winning bid on behalf of the athlete;
transferring the non-fungible token to the patron in exchange for the compensation if the winning bid is accepted.

10. A method comprising:
creating a profile for a patron using a processor and a memory;
determining that an athlete is associated with an intercollegiate sports team of a university by matching at least one information of the athlete to at least one qualifying credential;
identifying a set of parameters associated with a contractual relationship between the athlete and the university using the processor and the memory;
associating a set of restrictions to monetization of at least one of a name, an image and a likeness of the athlete based on the set of parameters associated with the contractual relationship between the athlete and the university;
determining a set of rules associated with a league in which the university participates with respect to compensation of the athlete;
automatically identifying a set of permissible revenue mechanisms available to the athlete within the set of rules of the league and the set of restrictions with respect to the contractual relationship between the athlete and the university;
deriving a monetization consideration from the set of parameters, the set of restrictions, and the league rules;
processing a set of bids for the monetization consideration from a plurality of patrons,
wherein the set of bids is a compensation that is offered as the at least one permissible revenue mechanism;
determining which is a winning bid of the set of bids from the plurality of patrons;
automatically accepting the winning bid on behalf of the athlete; and
transferring the monetization consideration to the patron in exchange for the compensation if the winning bid is accepted by the athlete.

11. The method of claim 10 further comprising:
forming a license agreement in a variety of permutations based on artificial intelligence algorithm that analyzes at least one of a popularity of the athlete, a skill level of the athlete, a popularity of the university, a popularity of the intercollegiate sports team, a popularity of the league, a probabilistic playing career duration of the athlete, and potential sponsorship avenues likely available to the athlete in a present time and a foreseeable future.

12. The method of claim 11 further comprising:
permitting the patron to compensate the athlete pursuant to the license agreement by purchasing the monetization consideration in the form of a non-fungible token along with a set of privileges of ownership of the non-fungible token along with a set of rights licensed from the athlete to the patron.

13. The method of claim 12 wherein:
the non-fungible token automatically encapsulates at least a portion of the set of permissible revenue mechanisms along with the license agreement.

14. The method of claim 13 further comprising:
after receiving the set of bids, confirming the athlete's identity by prompting the athlete to confirm the at least one athlete information.

15. The method of claim 14 further comprising:
creating an account for the athlete if the athlete confirms the at least one information of the athlete is at least one qualifying credential.

16. The method of claim 15 further comprising:
generating a taxation report that is personalized to the athlete detailing an income received from the patron and a tax liability of the athlete.

17. The method of claim 16 further comprising:
generating a compliance report specific to the athlete wherein at least one of a payment amount, a patron information, a timestamp, and at least one athlete information is accessible to the university.

18. The method of claim 17 further comprising:
determining an access permission for the university; and
permitting the university to access the compliance report based on the determination of the access permission for the university.

19. The method of claim 10 further comprising:
analyzing an activity of the patron for a violation wherein the violation bars the patron from compensating the athlete.

20. A system, comprising:
a processing system having a processor and a memory;
a network; and
a plurality of submodules to:
determine that an athlete is associated with an intercollegiate sports team of a university by assessing at least one information of the athlete for a qualifying credential;
identify a set of parameters associated with a contractual relationship between the athlete and the university using the processor and the memory;
associate a set of restrictions to monetization of at least one of a name, an image and a likeness of the athlete based on the set of parameters associated with the contractual relationship between the athlete and the university;
determine a set of rules associated with a league in which the university participates with respect to compensation of the athlete;
automatically identify a set of permissible revenue mechanisms available to the athlete within the set of rules of the league and the set of restrictions with respect to the contractual relationship between the athlete and the university;
form a license agreement in a variety of permutations based on artificial intelligence algorithm that analyzes at least one of a popularity of the athlete, a skill level of the athlete, a popularity of the university, a popularity of the intercollegiate sports team, a popularity of the league, a probabilistic playing career duration of the athlete, and potential sponsorship avenues likely available to the athlete in a present time and a foreseeable future;
generate a non-fungible token which automatically encapsulates at least a portion of the set of permissible revenue mechanisms along with the license agreement;
permit a patron to compensate the athlete pursuant to the license agreement by purchasing the non-fungible token along with a set of privileges of ownership of the non-fungible token along with a set of rights licensed from the athlete to the patron;
generate a taxation report that is personalized to the athlete;
create a compliance report specific to the athlete wherein at least one of a payment amount, a patron information, a timestamp, and an athlete information is accessible to the university;
determine an access permission for the university; and
permit the university to access the compliance report based on the determination of the access permission for the university.
analyze an activity of the patron for a violation wherein the violation bars the patron from compensating the athlete.
